(19) United States
(12) Patent Application Publication
(10) Pub. No.: US 2009/0164332 A1
(43) Pub. Date: Jun. 25, 2009

(54) METHOD TO MAXIMIZE AND STABILIZE MARKET SHARE AND PROFITS

(76) Inventor: Thomas Shih An Lee, Vancouver (CA)

Correspondence Address: VERMETTE & CO., SUITE 320 - 1177 WEST HASTINGS STREET, VANCOUVER, BC, V6E2K3, CA

(21) Appl. No.: 11/961,968

(22) Filed: Dec. 20, 2007

(51) Int. Cl. G06Q 30/00; G06Q 40/00

(52) U.S. Cl. 705/26; 705/35

(57) ABSTRACT

The method of the invention is based on a membership-only association (“MOA”). Preferably, the MOA operates as a not-for-profit entity having a formal organization such as a corporation or LLC. MOA receives membership fees to pay for accounting fees, legal fees, product liability insurance, and year-end buy backs of dead back-up inventory The MOA solicits retailers, designers, wholesalers, and manufacturers, or some combination thereof, to become members of the association Applicants for membership are screened based on criteria determined by founding members of the MOA. Once accepted, the prospective member enters into a contractual relationship with the MOA The types of members include, by way of example, Design Members, Supply Members, Logistical Wholesale Members, and Retail Members. Administration, logistics, and communications among the Design, Retail, and Logistical Wholesale Members are facilitated by a Support Entity.

### CROSS-REFERENCE TO RELATED APPLICATION

Not applicable

### BACKGROUND OF THE INVENTION

1. Field of the Invention

The field of the invention is retail business methods.

2. Statement of Problems Solved by the Invention

In many areas, particularly in the United States, the retail marketplace is dominated by that have become known in the vernacular as big-box retailers, also known as market-dominate vertically-integrated retailers (“MDVIR” herein). MDVIR's are organizations that own or control both upstream manufacturing and supply sources of their products as well as downstream distribution and retail operations. MDVIR's often operate on a national or international level at very large scales and distribute through chains of large retail outlets.

Because of the scale they operate at, MDVIR's are able to acquire or produce goods at very favorable wholesale prices and then sell those goods on the retail market at prices well below what smaller retail outlets are able to charge. In addition, MDVIR's, by virtue of their purchasing power, are able to “lock in” brands, which is to say, “lock out” smaller competitors from acquiring those brands.

Some MDVIR's, such as Wal-Mart and Target, sell a very diverse and generalized inventory ranging from car accessories to dog food to electronic goods. Other MDVIR's have a more directed market-focus. For instance, Lowes and Home Depot focus on markets related to home improvement and house building.

From the perspective of many independent retailers, the MDVIR model has been disastrous. In many small communities in the United States, entire “downtown” shopping districts have been shut down and abandoned when MDVIR's began operating in the area. Small, privately owned retail concerns are particularly hard hit.

But the MDVIR effects are not limited to the retail sector. MDVIR's also dominate at both the manufacturing and wholesale levels. When large percentages of retail purchases and manufacturing orders are controlled by MDVIR's, orders to smaller manufactures decrease and their prices must increase to compensate, thereby creating a destructive cycle. Wholesalers often fare no better, and in many cases the MDVIR paradigm can cut wholesalers out of the chain altogether by computerized inventory control that permits manufacturers to ship directly to retailers on a near-realtime demand basis.

The solution of these problems requires a marketing method that allows independent retailers to stabilize and maximize their market share and profits by gaining control over “upstream” aspects of the supply and distribution chain.

### BRIEF SUMMARY OF THE INVENTION

The present invention is a retail business method that can be employed by associations of retailers to compete with MDVIR's, and to maximize and stabilize market share and profits. The method can be practiced by virtually any retail market. It is sufficiently flexible that it can be fine tuned to accommodate large markets, such as, for instance, carpet and flooring, as well as smaller, niche markets such as lighting and hardware.

The method of the invention is based on a membership-only association (“MOA” herein). A MOA is established in a given retail area, for instance lighting, musical instruments, or hardware. Preferably, a MOA operates as a not-for-profit entity having a formal organization such as a corporation or LLC. MOA receives membership fees to pay for accounting fees, legal fees, product liability insurance, and year-end buy backs of dead back-up inventory. The MOA solicits retailers, designers, wholesalers, and manufacturers, or some combination thereof, to become members of the association. Applicants for membership are screened based on criteria determined by founding members of the MOA, for instance credit worthiness, quality of product, retail experience, reputation. Once accepted, the prospective member enters into a contractual relationship with the MOA. The types of members include, by way of example, Design Members, Supply Members, Logistical Wholesale Members, and Retail Members. Administration, logistics, and communications among the Design, Retail, and Logistical Wholesale Members are facilitated by a Support Entity. Preferably, the Support Entity includes a Support Member, which is a distinct legal entity from the MOA and may be a for-profit, or not-for profit organization.

In one embodiment of the method, all members follow a strict production schedule and production goals determined by MOA. For example, each Design Member must produce a minimum of 100 lines each quarter, and the Supply Members must have samples ready 30 days after receipt of sample request, while the Retail Members must participate in the viewing of the samples each quarter. After viewing samples, a Retail Member submits an order for goods and wares to the Support Entity. After pooling together the initial orders, the Support Entity seeks the most competitive suppliers who can meet MOA's quality, product design exclusivity, and shipment lead time criteria. The suppliers produce the required number of units and they may drop ship them product to the Retail Members or ship to a Logistical Wholesale Member. The Retail Member sells the units to its customers and gauges how well the product sells. The Retail Member may then place subsequent orders as well as a “back-up” order. The “back-up” order specifies quantities of the product that the Retail Member “might need” to service the urgent needs of their customers who cannot wait the normal lead time and are willing to pay a premium to obtain products faster. Back-up orders are gathered and processed in the same manner as regular orders, but these orders will ship to the Logistical Wholesale Members and held as inventory back-ups.

Retail Members pay a pre-determined amount according to the agreed upon formula to MOA. Support Entity receives the funds from the Retail Members and dispenses funds to the itself, the Designer Member, the Logistical Wholesale Member, and the Supply Member according to the agreed upon formula established by MOA.

The foregoing brief description represents but one of many embodiments of the method. For instance, depending on the particular market, the MOA may not include one or more of Design Members, Wholesale Members, Supply Members and Support Members. Examples of these alternative embodiments are disclosed below, others will be obvious to those of skill in the field after having read and understood the present disclosure.

### BRIEF DESCRIPTION OF THE DRAWINGS

In the drawings identical reference numbers are employed to identify identical steps and elements.

FIG. 1 is a representation of a transaction carried out using the method of the invention in a first preferred embodiment.

FIG. 2 is a representation of a transaction carried out using the method of the invention in a second preferred embodiment.

### DETAILED DESCRIPTION OF THE INVENTION

The inventive concepts and novel features of the invention are described here with reference to specific embodiments of the invention, which embodiments represent the best mode known to me for practicing the invention. The steps and elements of the invention and their structural and functional relationships may be easily comprehended by referring to this specification and the figures. However, it is to be noted that the embodiments described herein are representative of many possible embodiments that incorporate the inventive concepts of my invention.

### Glossary

Members-Only Association (“MOA”): Refers to the umbrella organization comprising the members and various persons or entities functioning directly in behalf of or under the control of the organization, for instance directors and staff.

Member: Members are defined herein according to their functional roles within the MOA. Retail Members provide retail services. Supply Members provide products, manufacturing services, supply services, and acquisition services necessary to bring the products into the market. Logistical Wholesale Members provide logistical and distribution services between the Supply Members and the Retail Members. Such services include, by way of example, wholesale, warehouse, inventory, shipping, and delivery services. Design Members provide services related to the design of new products. This list is not exhaustive of the types of memberships but rather exemplary of the types of functions that may be performed by classes of members. Generally, it is preferred that a membership is a contractual relationship between the MOA and the member entity.

Support Entity: Broadly defined to mean those persons or entities who perform support functions related to marketing, sourcing, advertising, administration, accounting, and coordination of communication between members. Support Entities may include a class of member referred to herein as a Support Member, which may be a for-profit or non-profit entity that provides support services to the MOA under a membership contract with the MOA. Additionally or alternatively, the Support Entity may include an administrative branch or employee of the MOA. Included within the definition of Support Entity may be directors and founding members of the MOA to the extent they provide support services and functions.

### First Preferred Embodiment

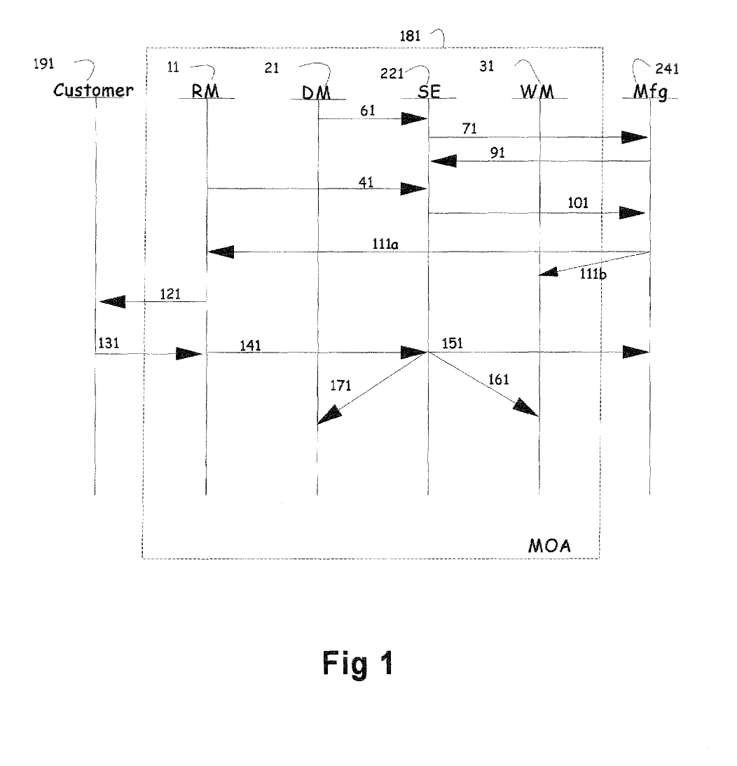

One preferred embodiment the method is shown in FIG. 1, which illustrates the various entities and their functional relationships. In the figure the sequence of steps in a transaction carried out by the method of the invention is represented roughly from top to bottom.

The MOA 181 illustrated in FIG. 1 is an association of, inter alia, Retail Members 11, Design Members 21, and Logistical Wholesale Members 31. In order to become a member of the MOA, designers, retailers, and wholesalers apply to the MOA for membership. The applicants are screened by Support Entity 221, and those found to meet the membership criteria enter into a membership contract with the MOA. Depending on the specific market, the membership contract may be non-exclusive or it may be exclusive.

Support Entity 221 carries out the coordination and logistical steps of the invention. Support Entity 221 may employ various administrative employees and may enter into contracts with accounting firms, computer technical support firms, and sourcing and manufacturing support firms for their services. In the preferred embodiment the Support Entity 221 includes a distinct for-profit legal Support Member that receives remuneration for its services from the sales of the products, as disclosed in detail below.

In the example shown in FIG. 1 does not include a class of supply members, but rather the supplier, such as manufacturer 241, is outside the MOA 181. This is an arbitrary decision that will be determined by each MOA based on an analysis of whether or not it is more efficient or cost-effective in market to enter into ad hoc contracts with manufacturers and suppliers. This illustrates the flexibility of the invention, which can accommodate a wide range of combinations of different types of memberships to best meet market limitations and opportunities.

The mode by which information is transmitted may be, by way of example, traditional paper and ink, FAX, or electronic transmission via phone lines or the Internet or some combination of these. In the most efficient, and hence the most preferred, embodiments, information flows electronically through a network of computers interconnected by means of telephone lines or other suitable means. For instance, an electronic signal generated at the point of sale of the Retail Member when an item is scanned at checkout is automatically sent to the Support Entity computer, thereby initiating the steps in the chain of order and supply as disclosed below. In these highly computerized embodiments of the invention, the Support Entity may consist primarily of the networked computers running software specially designed to carry out the steps of the method, thereby minimizing or eliminating human input.

FIG. 1 shows an example in which the Design Member 21 generates a custom product design, exclusive to the Retail Members, and transmits 61 the design to Support Entity 221. Preferably, new designs are continuously generated throughout the year, but only showcased quarterly, or as determined by MOA. At this point, Support Entity begins its work on sourcing and manufacturing management by getting the most competitive pricing, samples, production engineering drawings, and showroom management. The Support Entity transmits 71 the design and an order for samples to manufacturer 241 with whom the MOA has entered into a product exclusivity contract in which the manufacturer guarantee not to copy, duplicate or knock off the designs in any way, and to guarantee delivery lead time.

When the sample is ready, the manufacturer ships 91 the samples to the Support Entity, who displays the samples in its showroom, where all Retail Members can view the new product. Once the Retail Member decides on its “product mix,” it places an order 41 with Support Entity, specifying quantities and the types of shipment method. The Support Entity then places an order 101 with the to manufacture 241, advising the manufacture the quantities and destinations of shipment.

Manufacturer notifies Support Entity when the goods are ready to ship and ships the goods according to instructions from the Support Entity. Quantities may be split per Retail Member's original order instructions, with the majority of the order being shipped 111a to Retail Member's store and a small back-up quantity going 111b to the Logistical Wholesale Member 31.

Upon receipt of the goods, Retail Member 11 sells 121 the goods and receives payment 131 for them. The Retail Member then pays 141 the Support Entity a portion of the sales price according to a fund disbursement formula determined by MOA. The formula is a fixed formula for all products and all members. Upon receipt of the funds from the Retail Member, Support Entity disburses the appropriate funds to the Design Member 171, the Logistical Wholesale Member 161, and the manufacturer 151. If the Support Entity comprises a Support Member, then that Support Member also receives remuneration according to its contract with the MOA.

An example of such a funds disbursement formula used by the method is as follows:

R=FOB+S+F+D+W, where:

R is the price the Retail Member will pay Support Entity;

S is the Support Entity's handling cost;

F is the freight cost,

D is the design cost, and

FOB is product freight on board cost.

W is the wholesale logistic handling cost

### Second Preferred Embodiment

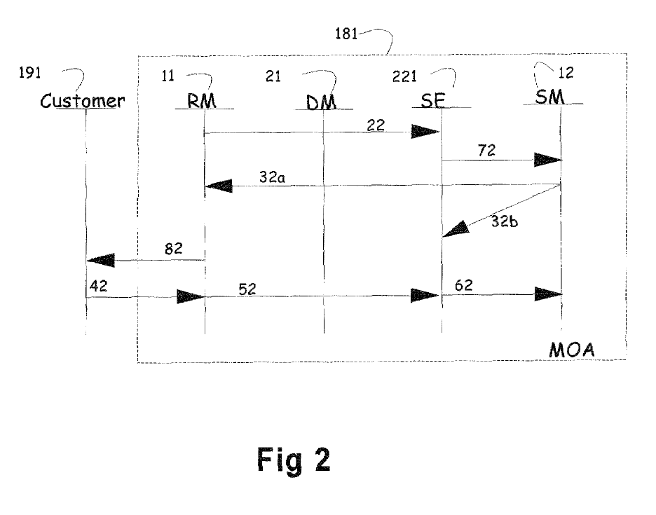

In FIG. 2 is illustrated an embodiment of the method featuring a simpler and more efficient MOA model. Here the MOA 181 includes Supply Members 12 but does not include Warehouse Members. This embodiment is particularly useful for markets in which the turnover of products is sufficiently high that the manufacturer can maintain an inventory on-premises and drop-ship directly to the Retail Member. Thus the types of memberships in this example include Support Entity 221, Retail Members 11, Design Members 21, and Supply Members 12.

In the example given in FIG. 2, Retail Member 11 sends an order 22 to Support Entity 221. In this example a new design is not a part of the order; consequently, the order is transmitted 72 directly to the Supply Member 12. The Supply Member drop-ships 32a the completed product directly to Retail Member 11 while simultaneously notifying 32b Support Entity. Upon receipt of goods, Retail Member sells 82 the goods to Customer 191, who pays 42 for the goods. Retail Member then pays 52 Support Entity, and Support Entity pays 62 the Supply Member.

It will be noted that in the embodiment illustrated in FIG. 2, the entire production/distribution/sales chain is contained within the MOA. This model provides the greatest control by the members of the entire chain by means of the contractual relationships between the members and the MOA. This embodiment of the method is applicable to many but not all markets.

One theoretical criticism of MDVIRs is that they are often to large and cumbersome to adapt quickly enough to market vicissitudes. Furthermore, they must provide a fixed “menu” of products to all retailers in all locations. As will be recognized by those of skill in the art, the present method overcomes these problems by allowing the Retail Members to individually control what items comprise their inventories. This advantage of the invention is particularly valuable in markets where geographical location plays an important part in consumer tastes.

The various steps of controlling information flow and transmitting information of the invention may be implemented by one or more computers executing instructions written on computer-readable media. The media and the computers may exist in distinct physical locations and be individually accessible by the individual members. For instance, copies of the instructions may reside on media that are maintained and accessed locally by each member. Alternatively, the media containing the instructions may be centrally located, for instance on computer or server maintained by the Support Entity, in which case the appropriate instructions are accessed by the computers of the individual members as required.

### SUMMARY

From the foregoing description the novelty, utility, means of practicing my invention will be readily apprehended. However, the foregoing description merely represents the best mode known to me as of the present date. The embodiment herein disclosed is not meant to be exclusive of other ways of practicing my invention, and it will be obvious to those of average skill in the field that other means of practicing the invention lie within the scope of this disclosure and the claims, below. It is to be understood that my invention is not limited to the embodiment disclosed above but encompasses any and all embodiments within the scope of the following claims.

1. A retail business method comprising the steps of:
a) forming an Association, wherein the Association comprises a Retail Member and a Support Entity;
b) the Retail Member transmitting a retail order to the Support Entity for goods;
c) the Support Entity transmitting a supply order to a supplier, wherein the order is for the goods of Step b);
d) the supplier supplying the goods ordered at Step c);
e) the Retail Member receiving the goods supplied at Step d);
f) the Retail Member disbursing a payment to the Support Entity for the goods received at Step e), and the Support Entity receiving the payment; and,
g) the Support Entity disbursing a portion of the payment received at Step f) to the supplier.

2. The method of claim 1 wherein the Support Entity comprises a Support Member.

3. The method of claim 1 wherein the Association formed at Step a) further comprises a Supply Member, and wherein the Supply Member is the supplier.

4. The method of claim 1 wherein the Association formed at Step a) further comprises a Logistical Wholesale Member, and wherein Step d) is performed by the supplier supplying the goods to the Logistical Wholesale Member, and wherein the method further comprises the step of the Logistical Wholesale Member shipping the goods to the Retail Member.

5. The method of claim 4 further comprising the steps of:
h) the Support Entity disbursing a portion of the payment received to at Step f) to the supplier; and
i) the Support Entity disbursing a portion of the payment received at Step f) to the Logistics Wholesale Member.

6. The method of claim 1 wherein the portion of the payment disbursed at Step f) is determined by reference to a fee disbursement formula

7. Computer-readable media upon which are written computer executable instructions for performing at least one of Steps b), c), f), and g) of the method of claim 1.
